(19) United States
(12) Patent Application Publication
(10) Pub. No.: US 2017/0217241 A1
(43) Pub. Date: Aug. 3, 2017

(54) ELEMENT FOR INCLINING A SIDE WALL OF A CHANNEL FOR BINDING OF PAGES

(71) Applicant: OPUS SPÓLKA Z OGRANICZONA ODPOWIEDZIALNOSCIA, Gliwice (PL)

(72) Inventors: Aleksander Macha, Gliwice (PL); Krystian Nawrat, Gliwice (PL); Klaudiusz Korczyk, Gliwice (PL); Henryk Pachla, Zabrze (PL)

(21) Appl. No.: 15/407,793

(22) Filed: Jan. 17, 2017

(30) Foreign Application Priority Data
Jan. 29, 2016 (PL) P.415966

(51) Int. Cl. B42C 13/00

(52) U.S. Cl. CPC B42C 13/00

(57) ABSTRACT

An element for inclining the side wall of the channel for binding of pages having sufficient rigidity is characterized in that it comprises on the front side thereof the longitudinal working plane of a variable inclination, which under the influence of an applied force pushes the side wall of the channel causing a change of its inclination in relation to the base of the channel uniformly along the entire plane of the side wall of the channel and clamping of the pages to be bound.

### CROSS-REFERENCE TO RELATED APPLICATION

This application claims the priority benefit of Polish Patent Application No. 415966, filed on Jan. 29, 2016, which is incorporated herein by reference in its entirety.

### FIELD OF THE INVENTION

The present invention relates to devices that support methods for binding of pages and can be used in an office and in bookbinding. In particular, the present invention relates to an element for inclining a side wall of a channel for binding of pages, which is placed in an inner space of an apparatus for binding of pages, as well as to an apparatus comprising the element and to a method for binding pages.

### BACKGROUND OF THE INVENTION

The devices or apparatuses for binding pages by means of pushing elements are known which, when a force is applied to them, change the inclination of either one side wall or both side walls of the channel for binding of pages in relation to the base of the channel while the plane of the wall or both walls is locally deformed. This deformation is a side effect of the method used for inclining the side wall of the channel with respect to its base.

Polish Patent No. 193931 discloses a device for binding multiple pages comprising a stationary bed and a channel pushing element capable to move above a lower part of the stationary bed of an “L”-shaped cross-section. The pushing element is provided with a deforming edge at its front side. The channel for binding pages according to the discussed solution is arranged on the stationary bed in such a way that one of the side walls of the channel, appropriately profiled, rests at the stationary bed while the other side wall of the channel is deformed. By using that solution, one undistorted side wall of the channel, being the front cover, is obtained. Thus, as a result of the deformation of the other side wall of the channel, a line leaving a visible trace of a deforming force is formed on the side wall of the channel along the contact of the edge of the pushing element with the side wall of the channel, closer to the upper edge of the side wall of the channel and parallel to it. The above-described problem occurs both in covers with the channel pasted inside the cover and in covers with the outside channel. In addition, the channel is often externally covered with varnish, paper or plastic veneer, which creates the risk of scratching the lacquered surface or breaking veneer material of the cover with the channel.

The aim of the invention is to develop an element for inclining a side wall of a channel for binding of pages, which will provide inclination of the side wall of the channel with respect to its base with minimal, if any, local deformation of the side wall plane, i.e., minimizing or eliminating traces of a deforming force, thereby providing a greater aesthetic of the binding.

### BRIEF SUMMARY OF THE INVENTION

The present invention provides an element for inclining a side wall of a channel for binding of pages, comprising on a front side thereof a longitudinal working plane having a variable inclination.

The element is configured to push the side wall of the channel to change an inclination of the side wall in relation to a base of the channel uniformly along an entire plane of the side wall and to clamp the pages to be bound.

Besides, the element is configured to push the side wall using pressure applied from a pushing element. Preferably, the element has an angle bar shape.

The present invention also provides an apparatus for binding of pages, comprising an element for inclining the side wall, the element comprising on a front side thereof a longitudinal working plane having a variable inclination. The element is configured to push the side wall to change an inclination of the side wall in relation to the base of the channel uniformly along an entire plane of the side wall and to clamp the pages to be bound. The element to push the side wall preferably has an angle bar shape.

The apparatus further comprises a pushing element configured to apply pressure to the element to push the side wall.

A method for binding pages comprises:

placing a channel for binding pages in the apparatus according to the invention;

placing the pages in the channel; and

clamping the pages by pushing the side wall of the channel using the element for inclining the side wall of the channel as described herein.

The apparatus further comprises a pushing element configured to apply pressure to the element for inclining a side wall. The element for inclining a side wall has an angle bar shape and is placed between the pushing element and the side wall of the channel which side is being inclined so that a plane of its front arm is parallel to the plane of the side wall.

By placing the element in the inner space of the device for binding of the pages, uniform and repeatable effect of the inclination of the entire longitudinal plane of the side wall of the channel in relation to its base can be achieved in a simple and effective way. As a result, the channel looks much better aesthetically. Moreover, if a surface of the channel is lacquered, a risk of scratching this lacquered surface or breaking the continuity of a veneer surrounding the channel can be minimized or eliminated.

### BRIEF DESCRIPTION OF THE DRAWINGS

FIG. 1 is a schematic cross-sectional view of the element for inclining the side wall of the channel for binding pages, in accordance with an embodiment of the disclosure, which is placed in the inner space of the apparatus for binding pages—before the inclining operation.

FIG. 2 is schematic cross-sectional view of the element for inclining the side wall of the channel for binding pages, in accordance with an embodiment of the disclosure, which is placed in the inner space of the apparatus for binding pages—during the inclining operation.

### DETAILED DESCRIPTION OF THE INVENTION

As described herein, the present invention provides an element for inclining a side wall of a channel for binding of pages. The front side of this element has a longitudinal working plane with a variable inclination. Specifically, the element is configured to push the side wall of the channel to change its inclination in relation to a base of the channel uniformly along an entire plane of the side wall and to clamp the pages being bound. Preferably, the element is configured to push the side wall using pressure applied from a pushing element.

Preferably, the element has an angle bar shape and is preferably 150-350 mm (e.g., 300 mm) long. Preferably, the angle bar-shaped element has distinct two flat arms or faces. It may be made of a metal sheet, such as a steel sheet that can be, e.g., 1.5 mm thick. The angle of the angle bar-shaped element can be, e.g., from 45 to 135 degrees.

The element for inclining the side wall of the channel should have rigidity that is sufficient to withstand a pushing force applied to it so as to push the side wall of the channel and to clamp the pages. The force used during the binding process depends, for example, on the size and the number of pages being bound, on the size of the channel for binding of pages, the material from which the pages are made, and the like. Preferably, this force is 0.5-2.5T (e.g., 2T). The size of the channel should be sufficient to accommodate the pages and to allow them to be bound.

The magnitude of the force is adapted to the shape of the channel and the type of the material of which the channel is formed, whereas the angle of the inclination of the side wall of the channel in relation to the base of the channel after the inclining operation may be a right or an acute angle, depending on the cross-section of the channel used. The element for inclining the side wall of the channel for binding of the pages may be used for inclining the side walls of the channels having both U- and V-shaped cross-sections.

The present invention also provides an apparatus for binding of pages, which includes the above-described element for inclining the side wall. This apparatus can also include a pushing element configured to apply pressure to the element to push the side wall.

To carry out binding process, a disposable channel can be inserted into the apparatus, pages can be inserted into the channel, and force can be applied to the channel. As a result, the pages can be bound by the compressed channel and the final product comprising the channel can be removed from the apparatus.

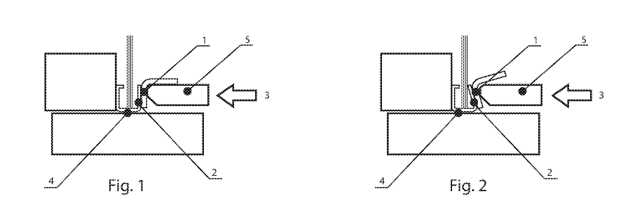

A preferred embodiment of the present invention will now be described in detail in accordance with FIGS. 1 and 2.

The element 1 for inclining the side wall of the channel for binding of pages has a shape of an angle bar, is made of a steel sheet that is 1.5 mm thick, and is 300 mm long.

The element 1 is positioned between the pushing element 5 and the side wall 2 of the channel to be inclined. This element 1 comprises, on the front side thereof, a longitudinal working plane of variable inclination. Under the influence of an applied force 3 of 2T, the element 1 pushes the side wall 2 of the channel of the U-shaped cross-section causing a change of its inclination in relation to the base 4 of the channel uniformly along the entire plane of the side wall 2 of the channel and clamping of the pages to be bound.

As shown in FIG. 1, the initially vertical front arm of the angle bar-shaped element 1 is parallel to the initially vertical side wall 2. As shown in FIG. 2, the side wall 2 is then inclined.

While the present invention has been described with reference to an exemplary embodiment, it is to be understood that the invention is not limited to this exemplary embodiment. The scope of the following claims is to be accorded the broadest interpretation so as to encompass modifications and equivalent structures and functions.

1. An element for inclining a side wall of a channel for binding of pages, the element comprising on a front side thereof a longitudinal working plane having a variable inclination,
wherein the element is configured to push the side wall of the channel to change an inclination of the side wall in relation to the base of the channel uniformly along an entire plane of the side wall and to clamp the pages to be bound.

2. The element according to claim 1, which is configured to push the side wall using pressure applied from a pushing element.

3. The element according to claim 1, which has an angle bar shape.

4. An apparatus for binding of pages comprising:
an element for inclining a side wall of a channel for binding of pages, the element comprising on a front side thereof a longitudinal working plane having a variable inclination,
wherein the element is configured to push the side wall to change an inclination of the side wall in relation to a base of the channel uniformly along an entire plane of the side wall and to clamp the pages to be bound.

5. The apparatus according to claim 4, further comprising a pushing element configured to apply pressure to the element to push the side wall.

6. The apparatus according to claim 4, wherein the element has an angle bar shape.

7. A method for binding pages, the method comprising:
placing a channel for binding of pages in the apparatus according to claim 4;
placing the pages in the channel; and
clamping the pages by pushing the side wall of the channel via the element for inclining the side wall of the channel.

8. The method according to claim 7, wherein the apparatus further comprises a pushing element configured to apply pressure to the element to incline the side wall.

9. The method according to claim 8, wherein the element for inclining the side wall has an angle bar shape having a front arm, and
wherein the element for inclining the side wall is between the pushing element and the side wall of the channel to be inclined so that a plane of the front arm is parallel to the plane of the side wall.
